(19) United States
(12) Patent Application Publication
(10) Pub. No.: US 2007/0166585 A1
(43) Pub. Date: Jul. 19, 2007

(54) RAPID RESPONSE SENSOR FOR CARBON MONOXIDE

(75) Inventors: Matthew Mench, State College, PA (US); Asok Ray, State College, PA (US); Shin Chin, State College, PA (US); Emin C. Kumbur, State College, PA (US)

Correspondence Address: GIFFORD, KRASS, SPRINKLE,ANDERSON & CITKOWSKI, P.C, PO BOX 7021, TROY, MI, 48007-7021, US

(73) Assignee: The Pennsylvania State University, University Park, PA (US)

(21) Appl. No.: 11/624,566

(22) Filed: Jan. 18, 2007

Related U.S. Application Data
(60) Provisional application No. 60/760,131, filed on Jan. 19, 2006.

(51) Int. Cl. H01M 8/04; G01N 27/26; G01F 1/64

(52) U.S. Cl. 429/22; 204/425; 205/775

(57) ABSTRACT

Species detection techniques are described based on measurement of a dynamic response to an external stimulus. One embodiment includes a voltage stimulus applied to a polymer electrolyte fuel cell (PEFC), with the response to said stimulus used to measure CO concentration on the anode catalyst. The principles of symbolic dynamics, finite state machines or a simplified peak response-to-asymptotic value measurement can be used to achieve a high degree of precision for measuring CO concentrations. Using the techniques of the present invention, CO poisoning of a fuel cell can be monitored and diagnosed before reaching a critical condition, thereby allowing early implementation of mitigation or graceful degradation strategies.

### CROSS-REFERENCE TO RELATED APPLICATION

This application claims priority of U.S. Provisional Patent Application Ser. No. 60/760,131, filed on Jan. 19, 2006, entitled “Rapid Response Sensor for Carbon Monoxide,” incorporated herein by reference.

### FIELD OF THE INVENTION

The present invention relates to chemical analysis, in particular to a rapid response sensor for carbon monoxide levels in a fuel cell.

### BACKGROUND OF THE INVENTION

The detection of a contaminant or contaminants within a gas stream can be critical to the successful operation of an industrial process. In particular, processes that use catalysts to initiate and/or enhance chemical and/or electrochemical reactions can become inefficient if contaminants come into contact with and poison the catalysts. One particular area of concern with the detection and concentration determination of a contaminant is the presence of carbon monoxide in the hydrogen feed gas of a fuel cell.

A fuel cell is an electrochemical energy conversion device designed to produce electricity from an external supply of fuel and oxidant. One typical fuel used in the operation of a fuel cell is hydrogen, the hydrogen supplied to an anode side, and an oxidant such as oxygen can be used and supplied to a cathode side. This type of fuel cell, typically known as a hydrogen cell, requires hydrogen to react with a catalyst at the anode where the hydrogen disassociates into protons and electrons. The protons are conducted away from the anode, through an electrolyte membrane located between the anode and cathode, to the cathode. The electrons are forced to travel through an external circuit from the anode to the cathode due to the electrolyte membrane being electrically insulating. The flow of electrons through the external circuit produces electricity. At the cathode, a catalytic reaction results in oxygen molecules reacting with the electrons and the protons to form water.

In order to properly control the performance of a polymer electrolyte fuel cell (PEFC), real-time knowledge of carbon monoxide (CO) levels, down to parts per million (ppm), is desired. The ability to detect CO at such low levels would be extremely valuable to enable real-time control and performance optimization of CO mitigation systems, while avoiding the difficulties and limitations inherent with the use of special hardware for CO content monitoring.

When detecting CO levels in a fuel stream entering a fuel cell, conventional systems utilize an additional piece of hardware that adds to the bulk and complexity of the system. One example is an infrared (IR) CO sensor, which is expensive, not robust, and measures the CO concentration in the hydrogen gas at the inlet of the fuel cell. However, the conditions measured at the inlet of the fuel cell may not accurately represent true poisoning at the anode catalyst surface, and certainly do not represent poisoning conditions along the entire fuel cell flow path, except at unreasonably high fuel flow rates where bulk CO ppm can be assumed uniform along the fuel flow channel. Thus improved CO level monitoring for fuel cell systems is needed.

In contrast to CO detection and monitoring within fuel cell systems, CO poisoning remediation technology is fairly developed. Air-bleeding, alternate catalyst selection, and other methods are well known. In air-bleeding, a small percentage (usually <5%) of air from the cathode side of the fuel cell is diverted to the anode side in order to promote chemical and electrochemical oxidation of CO and reduce poison coverage of the anode catalyst. The drawback of the air-bleeding technique is increased pumping requirements and electrochemical potential losses associated with fuel/oxidizer mixing in the anode feed. Additionally, the mixing of moist air from the cathode side with hydrogen on the anode side poses safety concerns. Therefore, knowledge of the exact level of time-varying CO in the feed stream is essential to enable optimized CO poisoning remediation technology in commercial systems. Furthermore, an improved technique for sensing time-varying. CO levels in the fuel flow of a PEFC would facilitate commercial applications of fuel cell technology, and be of great interest to industry.

### SUMMARY OF THE INVENTION

Species detection techniques are described based on measurement of a dynamic response to an external stimulus. One embodiment includes a voltage stimulus applied to a polymer electrolyte fuel cell (PEFC), with the response to the stimulus used to measure CO concentrations on an anode catalyst. The principles of symbolic dynamics, finite state machines or simplified peak response-to-asymptotic value measurements can be used to achieve a high degree of precision for measuring CO concentrations. Using the techniques of the present invention, CO poisoning of a fuel cell can be monitored and diagnosed before reaching a critical condition, thereby allowing early implementation of mitigation or graceful degradation strategies.

The techniques include the analysis of time series data from a PEFC using a novel technique for sensing time-varying CO levels in the fuel flow and allow for early prediction of incipient faults due to CO poisoning. Other advantages of the techniques include, but are not limited to: additional CO sensing hardware not required; high sensor sensitivity in the low to sub ppm range (not available with current sensors); rapid response to sudden changes in CO content; use in any system requiring accurate CO level quantification; and robust and reusable design.

In addition, a hardware free sensor is described. The sensor detects the true level of CO damage to a catalyst surface of a PEFC, when integrated with a power generating fuel cell, so that optimized remediation via air-bleed or other method can be employed. The sensor can also be used as an external device with limited hardware requirements.

### BRIEF DESCRIPTION OF THE DRAWINGS

FIG. 1 illustrates a polymer electrolyte fuel cell (PEFC);

FIG. 2 illustrates a finite state automation; and

FIGS. 3A and 3B show the current responses to a particular stimulus for various known levels of carbon monoxide (CO) in a polymer electrolyte fuel cell.

### DETAILED DESCRIPTION OF THE INVENTION

A stimulus-response approach for anomaly detection involving symbolic dynamics and finite state machine construction or peak-to-asymtotic voltage variation has been applied to develop a carbon monoxide (CO) sensor. The sensor may be calibrated using known levels of CO impurity. An anomaly measure is determined to quantify and detect changes in the CO composition from the nominal condition of no CO impurity in a fuel stream. Growth of the anomaly corresponds to an increase of CO ppm in the fuel flow, and if a surface such as an anode is present, subsequent anode surface poisoning. Online determination of the state of an anode catalyst health (CO ppm) using this anomaly detection methodology is used for intelligent control and mitigation of CO damage in fuel cell or other systems.

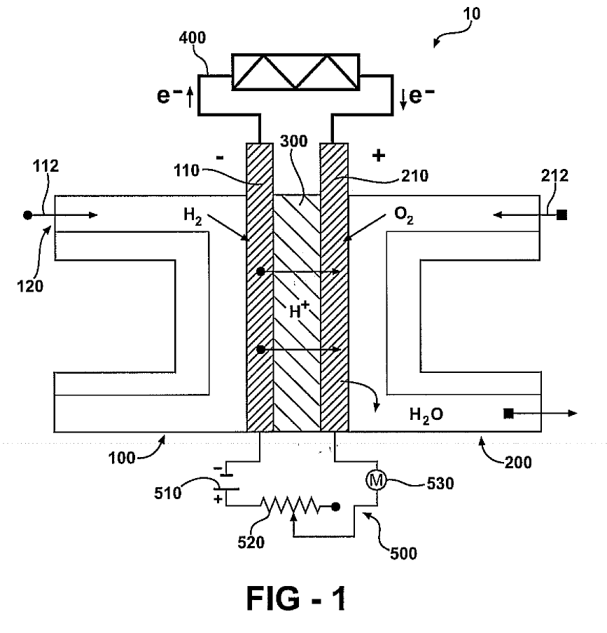

Turning to FIG. 1, a schematic representation of a fuel cell is shown generally at 10. The fuel cell 10 has an anode side 100 and a cathode side 200. The anode side 100 includes an anode 110 and a fuel gas 112, illustratively shown as hydrogen, that enters the anode side 100 at location 120. The hydrogen flows towards and comes into contact with the anode 110. Preferably, a catalyst (not shown), for example platinum, is present at the anode surface. Upon contacting the catalyst, the hydrogen undergoes an electrochemical reaction wherein hydrogen protons (H⁺) and electrons (e⁻) are produced.

A polymer electrolyte 300 is located between the anode 110 and a cathode 210. The electrolyte 300 affords for the movement of protons from the anode 110 to the cathode 210. In contrast, the electrolyte 300 is a barrier to electrons and thus forces the electrons to travel through an exterior circuit 400 in order to reach the cathode 210. The electrons passing through the external circuit 400 produce an electric current.

Upon reaching the cathode 210, the protons and electrons recombine to form hydrogen which reacts with oxygen gas 212 on the cathode side 200 to produce water (H₂O). In this manner, a fuel cell 10 supplied with fuel gas 112 to the anode side 100 and oxygen 212 to the cathode side 200 produces electricity.

Rapid online diagnosis and quantification of the level of CO in the fuel cell 10 can be achieved without the need for conventional CO sensors according to the present invention. FIG. 1 illustrates one embodiment wherein an electrical circuitry 500 uses a voltage source 510 and variable resistor 520 to apply an excess voltage of between 1.0 to 0.1 volts for a fixed period of time to the fuel cell 10. Preferably the fixed period of time wherein the excess voltage is applied to the fuel cell 10 is between 0.1 and 100 seconds. More preferably the fixed period of time is between 0.5 and 50 seconds, and even yet more preferably between 1 and 20 seconds. The electrical circuitry 500 also affords for the monitoring of the time-dependent response of the fuel cell and/or capturing any data associated with the time-dependent response of the fuel cell 10 using monitoring device 530. The monitoring of the time-dependant response of the fuel cell 10 to the excess voltage affords for the detection of CO on the anode catalyst. The stimulus response also affords for the determination of the concentration of CO in the H₂ fuel gas. In this manner, the fuel cell itself is a CO detector.

A major advantage of some embodiments of a CO sensor disclosed herein is the high degree of sensitivity in the low ppm range. A second major advantage of the invention is that the response curves are a strong function of operating temperature, so that the effective sensitivity and full-scale measuring of the sensor can be tailored to a particular application. For example, an application requiring sensitivity in the 100-1000 ppm range can be accommodated by variation of the temperature of the sensor or by variation of the catalyst to decrease CO absorption sensitivity. A third significant advantage of the invention is that the sensor need not be the actual power generating fuel cell itself, but can include an external component located inline with the incoming fuel stream. This configuration would be less expensive, could be used to protect an entire stack of fuel cells, would be easily replaceable and calibrated, and affords for the use of the sensor in any application requiring accurate knowledge of CO levels. Further, the sensor has a rapid response capable of detecting sudden transients common from fuel reforming stations. The concept of this dynamic response sensor is also extendable to the measurement of other low concentration species, for example sulfur, providing a suitable catalyst with adequate absorption/desorption characteristics is used. Although embodiments are described relating to fuel cell use, the disclosed invention can be used in any application requiring precise knowledge of CO levels. Additionally, the use of a transient response to a temporarily applied voltage to identify the level of a contaminant present, with tailorable sensitivity, can be extended beyond measurement of CO, providing suitable catalysts are used for each contaminant. One novel method of using the transient response to a temporarily applied voltage in order to detect a contaminant includes anomaly detection in complex systems and state machine construction from symbolic dynamics.

Anomaly Detection in Complex Systems

Anomaly is defined as a deviation from the nominal behavior and can be associated with parametric and non-parametric changes that may gradually evolve in time. Anomaly detection in dynamical systems is formulated as a two-time-scale problem, in which the phase trajectories evolve in the fast time scale and anomalies, if any, progress in the slow time scale. Progression of anomalies takes place in the form of parametric or non-parametric variations in the system response and the goal is to capture this information from the time series data as early as possible. The idea of behavior identification of complex nonlinear systems stems from an alternative approach using formal languages and transferring from continuous to discrete representation using symbolic dynamics. Symbolic dynamics models a dynamical system by using a space consisting of infinite sequences of abstract symbols, each sequence corresponding to a state of said systems, and a shift operator corresponding to the dynamics of said system. The approach of using automata theory for measure of complexity was suggested by Kolmogorov in terms of algorithmic complexity. This idea was primarily based on a deterministic automaton. Crutchfield and Young, based on this idea, applied it to stochastic automata, and constructed machines that are called ε-machines, as described in J. P. Crutchfield and K. Young, (1989), “Inferring Statistical Complexity”, Physical Review Letters 63, pp 105-108, and J. P. Crutchfield (1994), “The Calculi of Emergence, Computation, Dynamics and Induction”, Physica A, 75, pp 11-54.

A data sequence (e.g., time series data) can be converted to a symbol sequence by partitioning the space Ω (over which the data evolves) into finitely many discrete blocks as described in Badii, R. and Politi, A. (1997), Complexity, Hierarchical structures and scaling in physics, Cambridge University Press, United Kingdom.

If Φ≡{φ₁, φ₂, . . . , φₙ} is a partition of Ω (i.e.,

$${{⋃}^{l 1}}_{j = 1} {ϕ}_{j} = Ω$$

and Φⱼ∩φₖ=Ø∀j≠k, then each block φⱼεΦ is labeled as the symbol σⱼεΣ, where the symbol set Σ is called the alphabet consisting of n different symbols. (Note that a block φⱼεΦ is not necessarily a connected subset of the space Ω) Therefore, a data sequence {x₀, x₁, x₂, x₃, . . . }, obtained from a trajectory of the dynamical system, is converted to a symbol sequence {σᵢ, σⱼ, σₖ, . . . }. This symbol sequence characterizes the system dynamics represented by the data sequence.

Finding the dimensionality of the phase space of fuel cell dynamics can be difficult especially when the system is corrupted by noise. This phase space dimension is often very large, hence finding an appropriate partition in which the symbols are to be generated can be difficult or impossible. These difficulties are partially circumvented by using a wavelet transform of the time series data. After the application of the wavelet transform, the space of wavelet coefficients is partitioned as a function of scale and time shift. There are a number of ways to do this. One such method is described below.

Wavelet transform of time series data yields a graph of coefficients versus scale at each time shift. These graphs are stacked from end to end starting with the smallest value of scale and ending with the largest value. For example, the wavelet coefficients versus scale at time shift tₖ are stacked after the ones at time shift tₖ₋₁ to obtain the so-called scale series data in the wavelet space, which is analogous to the time series data in the phase space. The wavelet space is partitioned into equal horizontal slabs. The number of blocks in a partition is equal to the size of the alphabet and each block of the partition is associated with a symbol in the alphabet. For a given stimulus, the partitioning of wavelet space must remain invariant at all epochs of the slow time scale.

State Machine Construction from Symbolic Dynamics

Finite state machines are generated from the symbol sequences of a dynamical system and identify its behavioral pattern as described in D. Lind and B. Marcus (1999), An Introduction to Symbolic Dynamics and Coding, Cambridge University Press, UK. Furthermore, a finite state machine can be constructed from time series data using a wavelet transform.

Upon partitioning of the space of wavelet coefficients, a sequence of symbols is generated from the scale series data at selected epochs of the slow time. A finite state machine is then constructed from the symbol sequence, where the states of the machine are defined corresponding to a given alphabet of size [symbol] and window length [symbol] . The states are chosen as words of length [symbol] from the symbol sequence, thereby making the total number of states to be equal to the total permutations of the alphabet symbols within word of length [symbol] . Thus, the number of states is [symbol] because each symbol takes on one of the [symbol] possible values. Thus, the structure of the finite state machine is fixed for a given alphabet size [symbol] and window length [symbol] . Furthermore, the number of edges is also finite because of the finite alphabet size. The elements of the state transition matrix that is a stochastic matrix are identified from the symbol sequence. Therefore, the effects of an anomaly are reflected in the respective state transition matrices.

The states are joined by edges labeled by a symbol in the alphabet. The state machine moves from one state to another upon occurrence of an event as a new symbol in the symbol sequence is received. The machine language is complete in the sense that there are A different outgoing edges marked by different symbols σᵢεΣ; however, it is possible that the sum of these arcs may have zero probability.

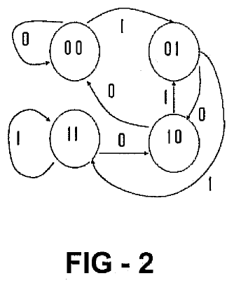

For machine construction, the window of length [symbol] is shifted to the right by one symbol upon receiving a new symbol σᵢεΣ, such that it retains the last ( [symbol] −1) symbols of the previous state and appends it with the new symbol σᵢ in the end. The symbolic permutation in the current window gives rise to a new state that might be a different state or the same state as the previous one, thus forming a self loop for that state. In this way, the entire state machine is constructed. As an example, let us choose [symbol] =2 and Σ={0,1}, i.e., [symbol] =2. Consequently, the number of states are: [symbol] =4; and the states are 00, 01, 10 and 11, as shown in the finite state automation illustrated in FIG. 2.

The choices of A and D depend on specific experiments, noise level and also the available computation power of the processing computer. A large alphabet may be noise-sensitive while a small alphabet could miss the details of signal dynamics. Similarly, while a larger value of D is more sensitive to signal distortion, it would create a much larger number of states requiring more computation power and longer time series data for convergence.

As the system trajectory evolves, different states are visited with different frequencies. The number of times a state is visited as well as the number of times a particular symbol σᵢεΣ is received, while sliding the window from a state leading to another state, is counted. In this way, the state probabilities as well as the state to state transition probabilities are calculated for each state.

The transition probabilities associated with state to state transitions are dependent on the dynamics of the complex system as reflected in the symbol sequence from which the state transition probabilities are generated. This is the key factor in detecting an anomaly because perturbations in the system dynamics may cause significant changes in the state probabilities that, of course, are also dependent on the space partitioning.

Having obtained the state probability vector at an (slow-time) epoch, the next step calculates the anomaly measure that signifies the change in asymptotic behavior of the dynamical system under the stimulus under consideration. First, the state probability vector under the nominal condition is determined as a benchmark. At different slow-time epochs (when an anomaly might have occurred), the state probability vector is determined again from the time series data collected on the fast-time scale at that particular time. The anomaly measure at a given (slow-time) epoch is obtained as the norm of the difference between the state probability vectors for the given epoch and the nominal condition. Obviously, the anomaly measure at the nominal condition is zero. In general, the anomaly measure at an epoch is different under different stimuli. With respect to the present invention, the behavior of a fuel cell system at different epochs is compared to its nominal behavior.

Using this perspective, the problem of anomaly detection is categorized into two parts, a forward problem and an inverse problem. The primary objective of the forward problem is to identify how the system performance is affected by gradually developing anomalies and to classify the parametric and non-parametric conditions that affect the system behavior. The problem of anomaly detection focuses on identification of the patterns followed by the system as the anomaly develops slowly.

Solution of the forward problem requires the following steps of: (1) generation of time series data from an experimental apparatus for various external stimuli; (2) partitioning of the phase space (or wavelet space) for generation of symbolic sequences (on the fast time scale) at different epochs of the slow time scale; (3) finite state machine construction from the symbol sequences and computation of the respective state probabilities; and (4) computation of anomaly measures as the norms of the differences of the respective state probability vectors from that under the nominal condition.

The inverse problem concentrates on inferring the anomalies based on the observed time series data. Since this problem may be ill-posed, selection of appropriate stimuli is critical for prediction of the anomaly range.

Given a symbol sequence at time to, the stationary state probability vector p₀ of the finite state machine is calculated at the nominal condition; p₀ represents a statistical pattern of the symbol dynamics. Subsequently, state probability vectors p₁, p₂, . . . pₖ, . . . are obtained from the same state machine at slow time epochs, t₁, t₂, . . . tₖ, . . . , based on the respective time series data. As stated earlier, the machine structure and partitioning are the same at all slow time epochs.

Behavioral pattern changes may take place in dynamical systems due to accumulation of faults and progression of anomalies. The pattern changes are quantified as deviations from the nominal pattern (i.e., the probability distribution at the nominal condition). The resulting anomalies (i.e., deviations of the evolving patterns from the nominal pattern) are characterized by a scalar-valued function, called Anomaly Measure Ã. The anomaly measures at slow time epochs t₁, t₂, . . . tₖ, . . . are obtained as:

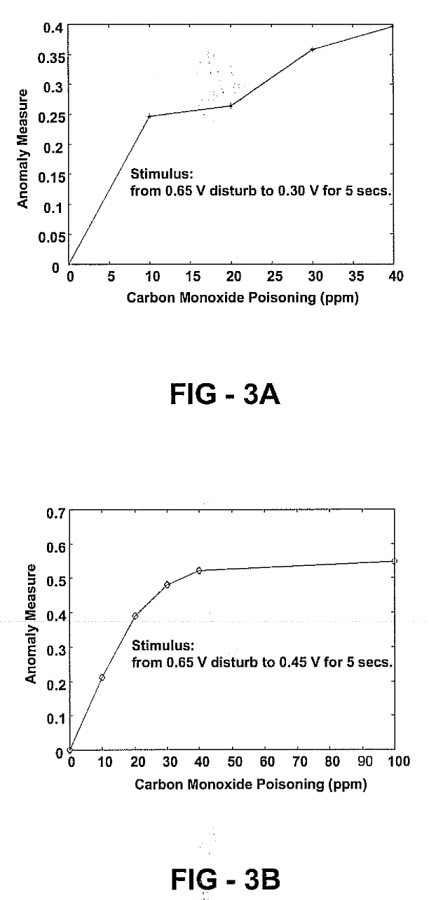

ψₖ=d(pₖ, p₀)

where the d(²;²) is an appropriately defined distance function. Often the distance function can be chosen as the Euclidean norm. FIGS. 3A and 3B described below represent such anomaly measures at a discrete number of slow time epochs.

For illustrative purposes only, and in no way limiting the scope of the invention, examples are provided wherein the present invention was used to determine the CO concentration in a fuel cell.

Example: PEFC Laboratory Apparatus used as CO Sensor

A custom-built 25 channel Arbin Instruments fuel cell test station was utilized to provide accurate current, voltage, reactant flowrate, humidity, pressure, and temperature control, A commercial 50 cm² superficial electrode area fuel cell was used (Lynntech, Inc., College Station, Tex.) along with a Lynntech membrane electrode assembly with a 51 μm thick Nafion™ 112 (DuPont) electrolyte and carbon supported platinum catalyst with 0.5 mg-Pt/cm² loading on both electrodes. The gas diffusion layer used on both electrodes was single sided ELAT® (De Nora North America, Inc). An experimentally optimized compression torque of 3.95 N-m (35 in-lbs) was used to ensure a homogenous pressure distribution of the current collector landings on the MEA and to minimize the electrical contact resistance between landings and the gas diffusion layer.

For anode flow, hydrogen gas with different levels of CO ppm was used from certified compressed gas cylinders (Matheson® Gas Products, Inc.). For the cathode flow, industrial compressed air (Breathing quality D, VNG®, WV) was used.

Time series data generated from a polymer electrolyte fuel cell (PEFC) laboratory apparatus were tested for early prediction of incipient faults due to CO poisoning, which may not be easily detected by conventional CO measurement apparatus. The results presented represent a novel technique for sensing time-varying CO levels in the fuel flow of a PEFC.

Two different stimuli were used during testing, a perturbation from a steady-state cell voltage of 0.65 to 0.45 V for 5 seconds, and a perturbation from a steady-state cell voltage of 0.65 to 0.30 V for 5 seconds. For all testing, 10 individual stimulus peaks were taken (5 seconds of stimulus, followed by 5 seconds back at 0.65 V). Data acquisition of asymptotic cell response was measured at 1000 Hz.

An anomaly detection methodology was applied to test data generated from the PEFC laboratory apparatus. The stimulus-response method of anomaly detection was applied to detect growth of anomaly (CO poisoning in fuel cell). The current responses to a particular stimulus were observed for various known levels of CO in the anode fuel stream. A wavelet transform was performed for each current response and the wavelet coefficient space suitably partitioned to generate a string of symbols. A finite state machine was constructed from the string of symbols. The state probability vector of the finite state machine was then obtained. For the first stimulus, the state visit probability vectors at 0, 10, 20, 30 and 40 ppm of CO poisoning in the fuel cell were obtained. The anomaly measure at a given level of CO poisoning of the fuel cell was calculated by taking the 2-norm of the difference between the state probability vectors obtained for that level of CO poisoning and the nominal condition of the fuel cell. The nominal condition of the fuel cell is the pure hydrogen fuel cell with zero levels of CO poisoning.

FIGS. 3A and 3B display the anomaly measure of the fuel cell under CO poisoning under two different stimuli. In the top plate under the first stimulus (FIG. 3A), the anomaly measure monotonically increases as the CO poisoning in the anode fuel flow is increased from 0 to 40 ppm. Under the second stimulus (FIG. 2B), the anomaly measure smoothly increases as the CO poisoning in the anode fuel flow is increased from 0 to 100 ppm. In both cases, the proposed method detects the occurrence of CO poisoning at an early stage. The anomaly measure curve asymptotically increases for larger amounts of CO poisoning to a saturation value of approximately 0.55. Other data have show similar trends for different temperature and pressure operation.

A different embodiment of the present invention includes a simplified method of CO detection by examining the time-dependent response to a given stimulus in the form of a peak-to-asymptotic response value. That is, following the same experimental procedure as described above, the same data yield a highly accurate measure of the CO content. The magnitude of the peak to asymptote voltage output potential of the fuel cell after the electrical stimulus is found to be proportional to the CO ppm, with similar accuracy to the symbolic dynamic methodology. Thus, in this embodiment, complex mathematical manipulation of the online data is not needed and a simplified differencing operation is all that is required. This peak-to-asymptote differencing method is an improvement of the existing data reduction technique but still follows the same conceptual idea to utilize the transient system response to measure the CO content.

Other Examples

In one example, a sensor according to the present invention comprises a fuel cell (having first and second electrodes, the first electrode including a catalyst, an electrolyte, and a supply of fuel), and an electronic circuit operable to provide an electrical stimulus to the fuel cell and monitor the response of the cell to the stimulus. The catalyst is poisoned by a contaminant in the fuel supply, and the contaminant is detected by the transient response of the cell to the stimulus. The stimulus also removes most or substantially all of the contaminant from the catalyst and preferably is an overvoltage applied for a time period sufficient to oxidize most of the contaminant bound to the catalyst.

In a different example, the anode of a fuel cell includes a catalyst, such as platinum, that is poisoned by the contaminant CO in the hydrogen fuel supply. The role of the anode catalyst is to convert hydrogen gas into protons and electrons, thus poisoning of the catalyst by CO bound to the catalyst prevents the catalyst from performing this role. A stimulus is applied to the cell, so as to oxidize the carbon monoxide to carbon dioxide (CO₂). A stimulus is preferably an over-voltage of 0.4-0.5 V, or greater. The stimulus effectively sweeps the contaminant off the anode, as the carbon dioxide has much less affinity to the catalyst at higher potentials. With the stimulus removed, the anode catalyst is again poisoned by the contaminant, carbon monoxide. The change in cell potential, from peak (immediately after removal of the stimulus) to asymptote value, is correlated with the carbon monoxide potential. A simple calibration with known concentrations of carbon monoxide allows determination of a quantitative numerical relationship.

In another example, the sensor includes a miniature fuel cell in the upstream inlet line of a main fuel cell stack. A stimulus is applied from a battery, or any electrical circuitry operable to apply a brief overvoltage to the cell. In addition, the operational temperature of the fuel cell is changed to modify the operational range (in terms of concentrations of CO effectively detected).

Other contaminants than CO may also be detected wherein a sufficient stimulus is applied to oxidize or otherwise remove the contaminant from the catalyst, and the time-dependent response of the fuel cell monitored. A large enough stimulus, such as a 10 volt over-voltage, may oxidize many species of contaminant. The apparatus may be used to detect the presence of any contaminant, as long as there is catalytic poisoning. The catalyst may be provided with binding sites for certain contaminants. The apparatus may also be used to determine the oxidative potential of the contaminant, so as to help identify the contaminant. The oxidation products may be collected and analyzed. In other examples, the contaminant may be reduced, the cathode catalyst contaminated, or other electrochemical processes used to detect the presence of the contaminant.

In other examples, the stimulus may comprise another energy input to remove the contaminant from the catalyst, such as radiation (e.g. electromagnetic such as UV, or ultrasound), thermal energy, other electrical input, or other energy input. The fuel supply may also be switched to a known contaminant level fuel, or uncontaminated fuel source, for in-situ calibration or to assist removal of contaminants from the catalyst.

The temperature of the sensor itself may be controlled, so as to control the sensitivity range of the sensor. The output of the sensor may be used in improved remediation techniques, or to modify a reforming step in the fuel supply process. Other detected contaminants may include nitrogen oxides, sulfur oxides, sulfides, hydrogen sulfide, halogens, alcohols or other inorganic or organic compound. Embodiments of the present invention may also be used to detect biological agents. The term contaminant is not limiting, as the detected chemical species may be present for any reason, and the presence may not be undesirable in a specific application of the present invention.

The invention is not restricted to the illustrative examples described above. Examples are not intended as limitations on the scope of the invention. Methods, apparatus, compositions, and the like described herein are exemplary and not intended as limitations on the scope of the invention. Changes therein and other uses will occur to those skilled in the art. The scope of the invention is defined by the scope of the claims.

Patents, patent applications, or publications mentioned in this specification are incorporated herein by reference to the same extent as if each individual document was specifically and individually indicated to be incorporated by reference.

Having described our invention, we claim:

1. An electrochemical sensor for a chemical species, which chemical species is a contaminant in a fluid stream, comprising:
an electrochemical device having an electrode, said electrode having a catalyst facilitating a chemical reaction in a component of a fluid stream, said catalyst being capable of being poisoned by a contaminant in said fluid stream;
a voltage source, said voltage source operable to provide an electrical stimulus to said electrode; and
a monitor, said monitor operable to detect and monitor a time-dependent response of said electrode to said electrical stimulus,
said time-dependent response being correlatable with the presence and/or amount of said contaminant.

2. The sensor of claim 1, wherein said electrode is an anode of a fuel cell, said catalyst includes platinum, said component of said fluid stream is hydrogen gas, and the contaminant is carbon monoxide.

3. The sensor of claim 2, wherein the electrical stimulus is an overvoltage applied to said fuel cell,
the overvoltage being sufficient to oxidize molecules of said contaminant bound to said catalyst.

4. The sensor of claim 3, wherein the overvoltage is applied to the fuel cell for a time period of between 1 and 20 seconds.

5. The sensor of claim 2, wherein said time-dependent response is the magnitude of the peak-to-asymptotic output potential of said fuel cell at a time after the initiation of the electrical stimulus.

6. An electrochemical sensor for a chemical species, which chemical species is a contaminant in a fluid stream, said sensor comprising:
a fuel cell, said fuel cell having an anode and an anode catalyst facilitating a chemical reaction in a component of a fluid stream, said anode catalyst being capable of being poisoned by a contaminant in said fluid stream;
an electrical circuit, said circuit having a voltage source, a variable resistor and a monitor;
said voltage source and variable resistor operable to provide an overvoltage to said anode of said fuel cell; and
said monitor operable to detect and monitor a time-dependent response of said anode to said overvoltage,
the time-dependent response being correlatable to a contaminant bound to said anode catalyst.

7. The sensor of claim 6, wherein said overvoltage is sufficient to oxidize molecules of said contaminant bound to said anode catalyst.

8. The sensor of claim 6, wherein the circuit is operable to apply overvoltage to said anode for a time period of between 0.5 and 50 seconds.

9. The sensor of claim 6, wherein the time-dependent response to said overvoltage applied to said anode is the magnitude of peak-to-asymptotic output potential of said fuel cell after the initiation of the overvoltage.

10. The sensor of claim 6, wherein said fuel cell is operable to facilitate a chemical reaction in a fuel gas.

11. A method for detecting the presence and/or a concentration of a contaminant within a fluid stream, the method comprising:
exposing a catalyst to a fluid stream, the fluid stream having a contaminant therein, the contaminant poisoning the catalyst;
applying a stimulus to the catalyst; and
monitoring the time-dependent catalyst performance to the stimulus, the time-dependent catalyst performance being correlatable to presence and/or concentration of the contaminant bound to the catalyst.

12. The method of claim 11, wherein applying the stimulus to the catalyst removes the contaminant from the catalyst.

13. The method of claim 11, wherein the stimulus is an electrical potential sufficient to oxidize the contaminant bound to the catalyst; and
monitoring the time dependence of the catalyst performance comprises monitoring the output potential of a fuel cell with the catalyst therein.

14. The method of claim 11, wherein the contaminant is carbon monoxide.

15. The method of claim 13, wherein the contaminant is carbon monoxide within a fuel gas supplied to the fuel cell.
